(19) United States
(12) Patent Application Publication
(10) Pub. No.: US 2025/0212243 A1
(43) Pub. Date: Jun. 26, 2025

(54) METHOD AND DEVICE FOR CANCELING MULTI-CARRIER REAL SELF-INTERFERENCE

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/848,401

(22) PCT Filed: Mar. 21, 2022
(86) PCT No.: PCT/CN2022/082065

§ 371 Date: Sep. 18, 2024

(51) Int. Cl. H04W 72/541; H04B 1/525; H04L 5/00; H04W 52/24

(52) U.S. Cl. CPC H04W 72/541; H04B 1/525; H04L 5/0073; H04W 52/241

(57) ABSTRACT

A method, device and computer readable medium for cancelling multi-carrier real self-interference in a wireless communication network. The multi-carrier real self-interference is canceled by: in response to the presence of potential self-interference in a multi-carrier combination of a terminal device, performing real self-interference determination on the potential self-interference; and in response to determining that real self-interference is present in the multi-carrier combination, sending an instruction message to a network device, the instruction message being used for instructing the network device to perform an interference avoidance operation on the multi-carrier combination. Therefore, whether real self-interference is present when a terminal works under a multi-carrier condition can be determined, and an instruction message is generated according to the real self-interference and sent to a network device, so that the network device performs an interference avoidance operation according to the instruction message.

### CROSS-REFERENCE TO RELATED APPLICATION

The present application is a U.S. National Phase of International Patent Application No. PCT/CN2022/082065 filed on Mar. 21, 2022. The contents of the above-cited application are hereby incorporated by reference for all purposes.

### BACKGROUND OF THE INVENTION

For a higher transmission rate and a larger system capacity, multi-carrier technologies have been widely used in radio communication systems, such as a 4th generation (4G) or 5th generation (5G) communication system. The multi-carrier technologies include carrier aggregation (CA) and dual connectivity technologies, dual connectivity (DC), EUTRA-NR dual connection (EN-DC), etc. However, when simultaneous multi-carrier uplink and downlink transmission is implemented at some frequency band combinations, real self-interference problems will be caused, such as harmonic interference, adjacent channel interference, and intermodulation interference. In consequence, uplink transmission of one carrier will interfere in downlink transmission of another carrier, and sensitivity loss will be caused. In order to ensure performance of carrier aggregation, a combination in a worst case is generally specified in a protocol, and a terminal can report its ability to support simultaneous uplink and downlink transmission or not.

### SUMMARY OF THE INVENTION

Examples of the disclosure provide a method and device for canceling multi-carrier real self-interference, which are performed to the technical field of communication.

An example of the disclosure provides a method for canceling multi-carrier real self-interference. The method is performed by a terminal device. The method includes: conducting, in response to determining that potential self-interference is encountered by a multi-carrier combination of the terminal device, real self-interference determination on the potential self-interference; and transmitting, in response to determining that real self-interference is encountered by the multi-carrier combination, an instruction message to a network device. The instruction message is configured to instruct the network device to conduct interference avoidance on the multi-carrier combination.

In the example of the disclosure, in response to determining that the potential self-interference is encountered by the multi-carrier combination of the terminal device, real self-interference determination is conducted on the potential self-interference; and in response to determining that the real self-interference is encountered by the multi-carrier combination, the instruction message is transmitted to the network device. The instruction message is configured to instruct the network device to conduct interference avoidance on the multi-carrier combination. Thus, through the above method, whether the real self-interference is encountered by the multi-carrier combination may be determined, and in response to existence of the real self-interference, the instruction message may be transmitted to the network device. In this way, the network device can conduct interference avoidance conveniently, and influence of the real self-interference on a normal frequency band can be reduced or eliminated.

In a possible embodiment, the conducting real self-interference determination on the potential self-interference includes:
determining interference information of the potential self-interference; and
determining whether the potential self-interference is the real self-interference according to the interference information.

In a possible embodiment, the determining whether the potential self-interference is the real self-interference according to the interference information includes:
determining that a plurality of potential self-interference are encountered by the multi-carrier combination; and
determining, for potential self-interference, whether the potential self-interference is the real self-interference according to the interference information of the potential self-interference.

In a possible embodiment, the determining whether the potential self-interference is the real self-interference includes:
determining current first transmission power of the terminal device and maximum second transmission power supported by the terminal device according to the interference information of the potential self-interference;
obtaining a difference between the first transmission power and the second transmission power; and
determining, in response to determining the difference to be greater than a set value, that the potential self-interference is the real self-interference.

In a possible embodiment, the determining current first transmission power of the terminal device and maximum second transmission power supported by the terminal device according to the interference information of the potential self-interference includes:
determining one carrier or a plurality of carriers causing interference from the multi-carrier combination according to the interference information of the potential self-interference;
computing the sum of the transmission power of the one carrier or the plurality of carriers causing interference, and obtaining the first transmission power; and
determining maximum transmission power supported by the one carrier or the plurality of carriers causing interference as the second transmission power.

In a possible embodiment, the computing the sum of the transmission power of the one carrier or the plurality of carriers causing interference, and obtaining the first transmission power include:
determining an interference type of self-interference on the basis of the interference information;
determining, in response to determining that the interference type is intermodulation interference, that the plurality of carriers causing interference exist in the multi-carrier combination, computing the sum of the transmission power of the plurality of carriers causing interference, and obtaining the first transmission power; and
determining, in response to determining that the interference type is adjacent channel interference or harmonic interference, that one carrier causing interference exists in the multi-carrier combination, and using the transmission power of the one carrier causing interference as the first transmission power.

In a possible embodiment, the determining that potential self-interference is encountered by a multi-carrier combination of the terminal device includes:
determining whether the potential self-interference is encountered by the multi-carrier combination according to frequency information of a carrier in the multi-carrier combination of the terminal device.

In a possible embodiment, the method further includes:
continuing, in response to determining that no real self-interference is encountered by the multi-carrier combination, monitoring the potential self-interference and determining the real self-interference.

In a second aspect, an example of the disclosure provides another method for canceling multi-carrier real self-interference. The method is performed by a network device. The method includes:
receiving an instruction message transmitted by a terminal device, where the instruction message is transmitted by the terminal device in response to determining that real self-interference is encountered by a multi-carrier combination used; and
conducting interference avoidance operation on the multi-carrier combination according to the instruction message.

In a possible embodiment, the conducting interference avoidance operation on the multi-carrier combination includes:
scheduling uplink and downlink work of two carriers encountering the real self-interference at different times.

In a possible embodiment, the conducting interference avoidance operation on the multi-carrier combination includes:
adjusting transmission power of the two carriers encountering the real self-interference.

In a possible embodiment, the adjusting transmission power of the two carriers encountering the self-interference includes:
adjusting transmission power of one of the two carriers encountering the self-interference, and maintaining transmission power of the other carrier; and
adjusting the transmission power of the two carriers encountering the self-interference simultaneously.

In a third aspect, an example of the disclosure provides a communication device. The communication device has some or all of the functions of a terminal device in the method instance, according to the first aspect. For instance, the communication device may have functions in some or all examples of disclosure or may have a function of independently implementing any one of the disclosure examples. The function may be achieved by hardware or by executing corresponding software with hardware. The hardware or software includes one or more units or modules corresponding to the above functions.

In an embodiment, a structure of the communication device may include a transceiver module and a processing module. The processing module is configured to support the communication device to execute a corresponding function in the above method. The transceiver module is configured to support communication between the communication device and other devices. The communication device may further include a storage module. The storage module is configured to be coupled to the transceiver module and the processing module, and stores a computer program and data necessary for the communication device.

As an instance, the processing module may be a processor, the transceiver module may be a transceiver or a communication interface, and the storage module may be a memory.

In a fourth aspect, an example of the disclosure provides another communication device. The communication device has some or all of the functions of a network device in the method instance, according to the second aspect. For instance, the communication device may have functions in some or all examples of disclosure or may have a function of independently implementing any one of the disclosure examples. The function may be achieved by hardware or by executing corresponding software with hardware. The hardware or software includes one or more units or modules corresponding to the above functions.

In an embodiment, a structure of the communication device may include a transceiver module and a processing module. The processing module is configured to support the communication device in executing a corresponding function using the above method. The transceiver module is configured to support communication between the communication device and other devices. The communication device may further include a storage module. The storage module is configured to be coupled to the transceiver module and the processing module, and stores a computer program and data necessary for the communication device.

As an instance, the processing module may be a processor, the transceiver module may be a transceiver or a communication interface, and the storage module may be a memory.

In a fifth aspect, an example of the disclosure provides a communication device. The communication device includes a processor. The processor invokes a computer program in a memory, so as to execute the method according to the first aspect.

In a sixth aspect, an example of the disclosure provides a communication device. The communication device includes a processor. The processor invokes a computer program in a memory, so as to execute the method according to the second aspect.

As an instance, the processing module may be a processor, the transceiver module may be a transceiver or a communication interface, and the storage module may be a memory.

In a seventh aspect, an example of the disclosure provides a communication device. The communication device includes a processor and a memory. The memory stores a computer program. The processor executes the computer program stored in the memory, such that the communication apparatus executes the method according to the first aspect.

In an eighth aspect, an example of the disclosure provides a communication device. The communication device includes a processor and a memory. The memory stores a computer program. The processor executes the computer program stored in the memory, such that the communication apparatus executes the method according to the second aspect.

In a ninth aspect, an example of the disclosure provides a communication device. The device includes a processor and an interface circuit. The interface circuit is configured to receive a code instruction and transmit the code instruction to the processor. The processor is configured to run the code instruction, such that the apparatus executes the method according to the first aspect.

In a tenth aspect, an example of the disclosure provides a communication device. The device includes a processor and an interface circuit. The interface circuit is configured to receive a code instruction and transmit the code instruction to the processor. The processor is configured to run the code instruction, such that the apparatus executes the method according to the second aspect.

In an eleventh aspect, an example of the disclosure provides a communication system. The system includes the communication apparatus according to the third aspect and the communication apparatus according to the fourth aspect. Alternatively, the system includes the communication device according to the fifth aspect and the communication device according to the sixth aspect. Alternatively, the system includes the communication device according to the seventh aspect and the communication device according to the eighth aspect. Alternatively, the system includes the communication device according to the ninth aspect and the communication device according to the tenth aspect.

In a twelfth aspect, an example of the disclosure provides a computer-readable storage medium. The computer-readable storage medium is configured to store an instruction used by the reception device. When the instruction is executed, the reception device is caused to execute the method according to the first aspect.

In a thirteenth aspect, an example of the disclosure provides a readable storage medium. The readable storage medium is configured to store an instruction used by the transmission device. When the instruction is executed, the transmission device is caused to execute the method according to the second aspect.

In a fourteenth aspect, the disclosure further provides a computer program product including a computer program. When the computer program product runs on a computer, the computer is caused to execute the method according to the first aspect.

In a fifteenth aspect, the disclosure further provides a computer program product including a computer program. When the computer program product runs on a computer, the computer is caused to execute the method according to the second aspect.

In a sixteenth aspect, the disclosure provides a chip system. The chip system includes at least one processor and an interface, and is configured to support the reception device to achieve functions according to the first aspect, for instance, a function of determining or processing at least one of data and information involved in the above method. In a possible design, the chip system further includes a memory. The memory is configured to store a computer program and data necessary for the reception device. The chip system may be composed of chips, or may include a chip and other discrete devices.

In a seventeenth aspect, the disclosure provides a chip system. The chip system includes at least one processor and an interface, and is configured to support the transmission device to achieve functions according to the second aspect, for instance, a function of determining or processing at least one of data and information involved in the above method. In a possible design, the chip system further includes a memory. The memory is configured to store a computer program and data necessary for the transmission device. The chip system may be composed of chips, or may include a chip and other discrete devices.

In an eighteenth aspect, the disclosure provides a computer program. When the computer program runs on a computer, the computer is caused to execute the method according to the first aspect.

In a nineteenth aspect, the disclosure provides a computer program. When the computer program runs on a computer, the computer is caused to execute the method according to the second aspect.

### BRIEF DESCRIPTION OF DRAWINGS

In order to more clearly describe technical solutions in examples of the disclosure or the background art, the accompanying drawings required for the examples of the disclosure or the background art will be illustrated below.

FIG. 1 is a schematic diagram of a framework of a communication system according to an example of the disclosure;

FIG. 2 is a schematic flow diagram of a method for canceling multi-carrier real self-interference according to an example of the disclosure;

FIG. 3 is a schematic flow diagram of another method for canceling multi-carrier real self-interference according to an example of the disclosure;

FIG. 4 is a schematic flow diagram of yet another method for canceling multi-carrier real self-interference according to an example of the disclosure;

FIG. 5 is a schematic flow diagram of still another method for canceling multi-carrier real self-interference according to an example of the disclosure;

FIG. 6 is a schematic structural diagram of a communication apparatus according to an example of the disclosure;

FIG. 7 is a schematic structural diagram of another communication device according to an example of the disclosure; and

FIG. 8 is a schematic structural diagram of a chip according to an example of the disclosure.

### DETAILED DESCRIPTION OF THE INVENTION

Examples will be described in detail here and shown in the accompanying drawings illustratively. When the following descriptions involve the accompanying drawings, unless otherwise specified, the same number in different accompanying drawings denotes the same or similar elements. The embodiments described in the following examples do not denote all embodiments consistent with the disclosure. On the contrary, the embodiments are merely instances of an apparatus and a method consistent with some aspects of the disclosure as detailed in the appended claims.

The terms used in the examples of the disclosure are merely to describe the specific examples, instead of limiting the examples of the disclosure. The singular forms such as “a,” “an” and “the” used in the examples of the disclosure and the appended claims are also intended to include the plural forms, unless otherwise clearly stated in the context. It is to be further understood that the term “and/or” used here refers to and includes any of one or more of the items listed in the associated list or all possible combinations.

It is to be understood that although the terms first, second, and third may be used to describe various information in the examples of disclosure, the information is not to be limited to the terms. The terms are merely used to distinguish the same type of information from each other. For instance, without departing from the scope of the examples of the disclosure, first information may also be referred to as second information, and similarly, second information may also be referred to as first information. Depending on the context, the word “if” used here can be interpreted as “when” or “at the time of” or “in response to determining”.

For the purpose of conciseness and easy understanding, the terms used for indicating a magnitude relation here are “greater than” or “smaller than,” and “higher than” or “lower than”. However, those skilled in the art can understand that the term “greater than” also covers a meaning of “greater than or equal to,” and the term “smaller than” also covers a meaning of “smaller than or equal to”; and the term “higher than” covers a meaning of “higher than or equal to,” and the term “lower than” also covers a meaning of “lower than or equal to”.

The disclosure relates to the technical field of communication, and particularly relates to a method and device for canceling multi-carrier real self-interference, in order to determine whether real self-interference occurs between carriers in multi-carrier transmission.

In order to facilitate understanding, the terms involved in the disclosure will be firstly introduced.

### 1. Maximum Sensitivity Degradation (MSD)

When simultaneous multi-carrier uplink and downlink transmission is implemented at some frequency band combinations, real self-interference problems will be caused, such as harmonic interference, adjacent channel interference, and intermodulation interference. In consequence, uplink transmission of one band interferes in downlink transmission of another band, and sensitivity loss is caused. Maximum sensitivity loss is defined as maximum desensitization.

### 2. Carrier Aggregation (CA)

In order to satisfy demands of improvement in single-user peak rate and system capacity, one of the most direct methods is to increase a transmission bandwidth of a system. Thus, a technology to increase the transmission bandwidth is introduced into an LTE-advanced system.

A CA function may support continuous or discontinuous carrier aggregation. A maximum available resource of each carrier is 110 resource blocks. Each user uses an independent hybrid automatic repeat request (HARQ) entity on each carrier. Each transmission block may only be mapped to a specific carrier. Physical downlink control channels (PDCCHs) on each carrier are independent of each other, so a design of R8 version may be reused, and resources may be allocated for physical uplink control channel (PUCCH) and PUSCH of each carrier through the PDCCH of each carrier.

For better understanding of a method for canceling multi-carrier real self-interference according to examples of the disclosure, a communication system applicable to the examples of the disclosure will be firstly described below.

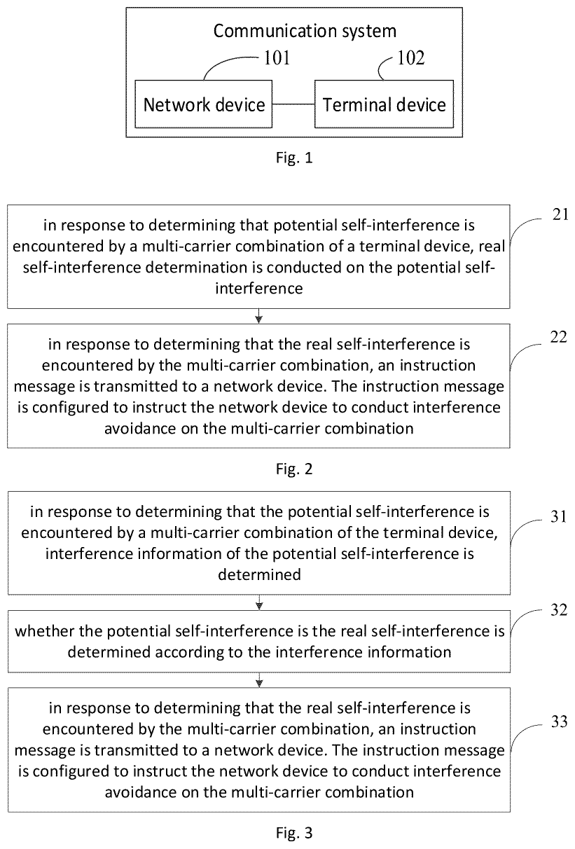

With reference to FIG. 1, FIG. 1 is a schematic diagram of a framework of a communication system according to an example of the disclosure. The communication system may include, but is not limited to, one network device and one terminal device. A number and a form of the devices shown in FIG. 1 are only illustrative and do not limit the examples of the disclosure. In practical application, the communication system may include two or more network devices and two or more terminal devices. For instance, the communication system shown in FIG. 1 may include one network device 101 and one terminal device 102.

It is to be noted that technical solutions of the examples of the disclosure may be applied to various communication systems, such as a long term evolution (LTE) system, a 5th generation (5G) mobile communication system, a 5G new radio (NR) system, or other novel mobile communication systems in the future. It is to be also noted that a side link in the example of the disclosure may also be referred to as a side link or a direct communication link.

The network device 101 in the example of the disclosure is an entity configured to transmit or receive a signal on a network side. For instance, the network device 101 may be an access network device. The access network device may be an evolved node b (enb), a transmission reception point (TRP), a next generation node b (gnb) in the NR system, a base station in other future mobile communication systems, or an access node in a wireless fidelity (wifi) system. The network device 101 may be a core network device. The core network device in the example of the disclosure may be a device in communication with an access network device. The core network device may be a 5G core network device, such as an access and mobility management function (AMF), or an evolved packet core (EPC) device, such as a mobility management entity (MME). The example of the disclosure does not limit a specific technology and a specific device form used by the network device. The network device according to the example of the disclosure may be composed of a central unit (CU) and a distributed unit (DU). The CU may also be referred to as a control unit. With a structure of CU-DU, protocol layers of the network device, for instance, a base station, may be separated. Functions of some protocol layers are centrally controlled by the CU while functions of the other or all protocol layers are distributed in the DU, and the DU is centrally controlled by the CU.

The terminal device 102 in the example of the disclosure is an entity, for instance, a mobile phone, configured to receive or transmit a signal on a user side. The terminal device may also be referred to as a terminal, user equipment (UE), a mobile station (MS), a mobile terminal (MT), etc. The terminal device may be a vehicle having a communication function, an intelligent vehicle, a mobile phone, a wearable device, Pad, a computer having a radio transceiving function, a virtual reality (VR) terminal device, an augmented reality (AR) terminal device, a radio terminal device in industrial control, a radio terminal device in self-driving, a radio terminal device in remote medical surgery, a radio terminal device in smart grid, a radio terminal device in transportation safety, a radio terminal device in smart city, a radio terminal device in smart home, etc. The example of the disclosure does not limit a specific technology and a specific device form used by the terminal device.

It may be understood that the communication system according to the examples of the disclosure is intended to describe the technical solution of the examples of the disclosure more clearly, instead of limiting the technical solution according to the examples of the disclosure. Those of ordinary skill in the art may know that the technical solution according to the examples of the disclosure is also applicable to similar technical problems with evolution of a system structure and emergence of new business cases.

A method for canceling multi-carrier self-interference and an apparatus according to the disclosure will be described in detail with reference to the accompanying drawings below.

With reference to FIG. 2, FIG. 2 is a schematic flow diagram of a method for canceling multi-carrier real self-interference according to an example of the disclosure. As shown in FIG. 2, the method is performed by a terminal device. The method may include, but is not limited to, the following steps:

S21, in response to determining that potential self-interference is encountered by a multi-carrier combination of a terminal device, real self-interference determination is conducted on the potential self-interference.

For purposes of improvement in transmission rate and system capacity, multi-carrier technologies have been widely used in radio communication systems, such as a 4th generation (4G) or 5th generation (5G) communication system. For instance, the technologies include carrier aggregation (CA) and dual connectivity technologies, dual connectivity (DC), EUTRA-NR dual connection (EN-DC), etc.

However, when simultaneous multi-carrier uplink and downlink transmission is implemented at some frequency band combinations, self-interference is likely to be caused, such as harmonic interference caused by interference of harmonic waves in carriers, adjacent channel interference caused by mutual interference between adjacent or close carriers, and intermodulation interference caused by a nonlinear component in a transmission channel. In consequence, uplink transmission of one carrier interferes in downlink transmission of another carrier, and self-interference is caused. In some examples, signal strength of self-interference at a reception end is much greater than that of a signal of a remote radio communication device at the reception end, such that normal communication can be obviously influenced, and even the terminal device can be completely interrupted and destroyed.

It is to be noted that the multi-carrier combination includes at least two carriers, and a specific number of the carriers is not limited. Interference occurs between the two carriers that interact with each other in the multi-carrier combination, or between a plurality of carriers. It is to be noted that types of self-interference between the plurality of carriers may be the same or not.

In the example of the disclosure, in response to a possibility of occurrence of the potential self-interference in the multi-carrier combination of the terminal device, power of the plurality of carriers may be obtained and compared with a power threshold, such that whether the potential self-interference is real self-interference may be determined.

In some examples, a potential self-interference problem is determined by a terminal. In one example, whether interference types such as harmonic interference, intermodulation interference and adjacent channel interference may be determined according to a configured frequency relation between the plurality of carriers. Optionally, whether the potential self-interference is encountered by the terminal device is determined through the following formulas:

$${f}_{INT} = a \times {f}_{TX 1} + b \times {f}_{RX 1} + c \times {f}_{TX 2} + d \times {f}_{RX 2} , and \qquad ( 1 )$$

$$B {W}_{INT} = a \times {CBW}_{TX 1} + c \times {CBW}_{TX 2} . \qquad ( 2 )$$

In the formulas, f_{INT} denotes an interference center frequency, f_{TX1} denotes a transmission frequency point of a first carrier, f_{RX1} denotes a reception frequency point of the first carrier, f_{TX2} denotes a transmission frequency point of a second carrier, f_{RX2} denotes a reception frequency point of the second carrier, BW_{INT} denotes an average channel bandwidth, CBW_{TX1} denotes an uplink bandwidth of a first carrier channel, CBW_{TX2} denotes an uplink bandwidth of a second carrier channel, and a, b, c and d may be looked up in a material safety data (MSD) sheet according to a frequency band of a carrier.

After BW_{INT} and f_{INT} are determined, the sum may be computed, and determination may be conducted according to the sum. It may be considered that the potential self-interference problem occurs when the following conditions are satisfied:

$$\vert {f}_{INT} \vert < \frac{B {W}_{INT} + {CBW}_{RX 1}}{2}$$

$$or$$

$$\vert {f}_{INT} \vert < \frac{B {W}_{INT} + {CBW}_{RX 2}}{2}$$

CBW_{RX1} denotes a downlink bandwidth of the first carrier channel, and CBW_{RX2} denotes a downlink bandwidth of the second carrier channel. In response to satisfying

$$\vert {f}_{INT} \vert < \frac{B {W}_{INT} + {CBW}_{RX 1}}{2} ,$$

the first carrier may be considered as an interference-causing carrier, and the second carrier may be considered as an interference-encountering carrier. In response to satisfying

$$\vert {f}_{INT} \vert < \frac{B {W}_{INT} + {CBW}_{RX 2}}{2} ,$$

the first carrier may be considered as an interference-encountering carrier, and the second carrier may be considered as an interference-causing carrier.

It is to be noted that, in response to simultaneously satisfying

$$\vert {f}_{INT} \vert < \frac{B {W}_{INT} + {CBW}_{RX 1}}{2} and \vert {f}_{INT} \vert < \frac{B {W}_{INT} + {CBW}_{RX 2}}{2} ,$$

the carrier may be an intermodulation carrier, and the first carrier and the second carrier are carriers interfering with each other.

The MSD sheet is shown in the following table. Values of a, b, c and d may be determined according to frequency bands of the multi-carrier combination, and a, b, c and d are integers. An absolute value of the sum of the value of an uplink coefficient a or c and the value of a downlink coefficient b or d is equal to a harmonic or intermodulation order that is obtained by experiments. Different carriers may correspond to different values.

| | | Uplink | | Downlink | | Harmonic or | Influenced | |
|---|---|---|---|---|---|---|---|---|
| Multi-carrier | Frequency | coefficient | | coefficient | | intermodulation | frequency | Interference |
| combination | band | a and c | | b and d | | order | band | type |
| DC_20A_n41a | 20 | a | 3 | b | 0 | 3 | N41 | Harmonic |
| | N41 | c | 0 | d | 1 | | | |
| DC_20A_n41a | 20 | a | 2 | b | 1 | 3 | 20 | Intermodulation |
| | N41 | c | 1 | d | 0 | | | |

In some other examples, the terminal may also determine whether a potential interference problem occurs according to a preset self-interference mapping table. That is, whether the potential self-interference is encountered may be determined by looking up carrier information of the first carrier and the second carrier in the table. It is to be noted that the preset self-interference mapping table includes a plurality of carriers encountering self-interference. For instance, each row includes carrier information of two carrier pairs encountering self-interference and a potential self-interference type corresponding to the carrier pairs. In the disclosure, the self-interference mapping table may be looked up on the basis of the carrier information of the first carrier and the second carrier. If a row in the table includes the first carrier and the second carrier, it is determined that the potential self-interference occurs between the two carriers, and a type of self-interference may be determined.

It is to be noted that, in the example of the disclosure, it is determined that a carrier that causes interference is defined as an interference-causing carrier and a carrier that encounters interference is defined as an interference-encountering carrier. When the interference type is the intermodulation interference, a number of interference-encountering carriers may be two.

Further, in response to failing to satisfy

$$\vert {f}_{INT} \vert < \frac{B {W}_{INT} + {CBW}_{RX 1}}{2} and / or \vert {f}_{INT} \vert < \frac{B {W}_{INT} + {CBW}_{RX 2}}{2} ,$$

it is considered that no potential self-interference occurs between the first carrier and the second carrier, and monitoring the first carrier and the second carrier may be continued.

S22, in response to determining that the real self-interference is encountered by the multi-carrier combination, an instruction message is transmitted to a network device. The instruction message is configured to instruct the network device to conduct interference avoidance on the multi-carrier combination.

In the example of the disclosure, in response to determining that the real self-interference is encountered by the multi-carrier combination, the instruction message may be transmitted to instruct a type, a magnitude and other data of the real self-interference, and the network device may conduct interference avoidance according to the instruction message.

It may be understood that different types of the real self-interference correspond to different interference avoidance. There are various interference avoidance strategies. For instance, two carriers are scheduled to work in uplink and downlink at different times, or downlink transmission power is increased, or uplink transmission power is decreased. The interference avoidance corresponding to a specific type of the real self-interference may be set according to actual needs, which is not limited here.

Through the example of the disclosure, whether the real self-interference is encountered when the terminal works under a multi-carrier condition is determined, and the instruction message is generated according to the real self-interference and transmitted to the network device, such that interference avoidance can be conducted by the network device according to the instruction message. In this way, whether the real self-interference is encountered by a plurality of carriers can be monitored, and the real self-interference can be canceled, such that influence of the real self-interference on sensitivity can be minimized.

With reference to FIG. 3, FIG. 3 is a schematic flow diagram of a method for determining whether potential self-interference is real self-interference according to an example of the disclosure. As shown in FIG. 3, the method is performed by a terminal device. The method may include, but is not limited to, the following steps:

S31, in response to determining that the potential self-interference is encountered by a multi-carrier combination of the terminal device, interference information of the potential self-interference is determined.

It is to be noted that reference may be made to any one of the embodiments of the examples of the disclosure for an embodiment of determining the potential self-interference.

In the example of the disclosure, there are various types of the interference information of the potential self-interference. For instance, the interference information may include transmission power and an interference type of the potential self-interference, a carrier causing interference, etc., which may be set according to actual needs and are not limited here. It may be understood that different types of potential self-interference correspond to different interference information obtained.

S32, whether the potential self-interference is the real self-interference is determined according to the interference information.

In the example of the disclosure, current first transmission power of the terminal device and maximum second transmission power supported by the terminal device may be determined according to the interference information of the potential self-interference, then a difference between the first transmission power and the second transmission power may be obtained, and finally, in response to determining the difference to be greater than a set value, it is determined that the potential self-interference the real self-interference.

It is to be noted that the sum of the transmission power of one carrier or a plurality of carriers causing interference is computed and determined as the first transmission power. It may be seen from the above description that a number of interference-causing carriers may be one or two. For instance, when the interference type is intermodulation interference, the number of interference-causing carriers is two, and first power may be obtained by computing the sum of power of two interference-causing carriers. When the interference type is adjacent channel interference or harmonic interference, first power may be power of the interference-causing carrier. Maximum transmission power supported by the one carrier or the plurality of carriers causing interference is determined as the second transmission power.

A preset value is a value preset by the terminal. In one example, a same unified value may be preset for different multi-carrier combinations and different interference types. In another example, different values may be preset according to different multi-carrier combinations. Alternatively, different values may be preset according to different combinations and different interference types.

In one example of the disclosure, if a multi-carrier combination simultaneously has a plurality of interference types, such as CA_n3-n78, it is determined that harmonic potential self-interference and intermodulation interference are encountered according to the method for determining the potential self-interference. In a case of harmonic interference, an interference-causing carrier is band n3 and an interference-encountering carrier is band n78. The first transmission power of the carrier combination encountering the potential self-interference is transmission power of the band n3. In a case of intermodulation interference, interference-causing carriers is bands n3 and n78 and an interference-encountering carrier is band n3. The first transmission power of the carrier combination encountering the potential self-interference is the sum of the transmission power of the band n78 and transmission power of the band n3. After the first transmission power and the second transmission power are obtained, the above two cases need to be determined separately. That is, whether a difference between current first power of n3 and second power supported by n3 is smaller than the preset value is determined. In addition, whether a difference between the current first power sum of n3 and n78 and second power supported by the interfering power under the multi-carrier condition is smaller than the preset value is determined. When the difference is smaller than the preset value, it is determined that the potential self-interference is not the real self-interference. When the difference is greater than the preset value, it is determined that the potential self-interference is the real self-interference.

S33, in response to determining that the real self-interference is encountered by the multi-carrier combination, an instruction message is transmitted to a network device. The instruction message is configured to instruct the network device to conduct interference avoidance on the multi-carrier combination.

In the example of the disclosure, in response to determining that the real self-interference is encountered by the multi-carrier combination, the instruction message may be transmitted to instruct a type, a magnitude and other data of the real self-interference, and the network device may conduct interference avoidance according to the instruction message.

It may be understood that different types of the real self-interference correspond to different interference avoidance. There are various interference avoidance strategies. For instance, two carriers are scheduled to work in uplink and downlink at different times, or downlink transmission power is increased, or uplink transmission power is decreased. The interference avoidance corresponding to a specific type of the real self-interference may be set according to actual needs, which is not limited here.

In one example of the disclosure, if a multi-carrier combination simultaneously has a plurality of interference types, such as CA_n3-n78, it is determined that harmonic potential self-interference and intermodulation interference are encountered according to the method for determining the potential self-interference. In a case of harmonic interference, the interference-causing carrier is band n3 and the interference-encountering carrier is band n78. Mutual interference between CA_n3 and n78 can be reduced by reducing the transmission power of the band n3, and further a possibility of the potential self-interference between the two carriers can be reduced. In a case of intermodulation interference, interference-causing carriers are bands n3 and n78 and an interference-encountering carrier is band n3. In order to reduce a possibility of the potential self-interference, the transmission power of the bands n3 and n78 can be simultaneously reduced.

Through the example of the disclosure, whether the real self-interference is encountered when the terminal works under a multi-carrier condition is determined, and the instruction message is generated according to the real self-interference and transmitted to the network device, such that interference avoidance can be conducted by the network device according to the instruction message. In this way, whether the real self-interference is encountered by a plurality of carriers can be monitored, and the real self-interference can be canceled, such that influence of the real self-interference on sensitivity can be minimized.

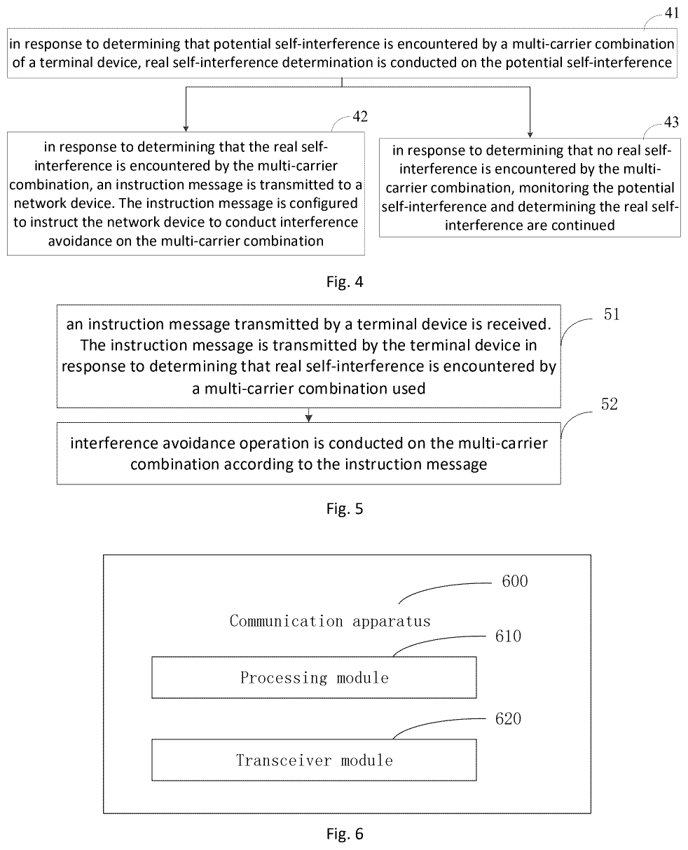

With reference to FIG. 4, FIG. 4 is a schematic flow diagram of another method for canceling multi-carrier real self-interference according to an example of the disclosure. As shown in FIG. 4, the method is performed by a terminal device. The method may include, but is not limited to, the following steps:

S41, in response to determining that potential self-interference is encountered by a multi-carrier combination of a terminal device, real self-interference determination is conducted on the potential self-interference.

Reference may be made to contents of the above examples for specific steps, which will not be repeated here.

S42, in response to determining that the real self-interference is encountered by the multi-carrier combination, an instruction message is transmitted to a network device. The instruction message is configured to instruct the network device to conduct interference avoidance on the multi-carrier combination.

Reference may be made to contents of the above examples for specific steps, which will not be repeated here.

S43, in response to determining that no real self-interference is encountered by the multi-carrier combination, monitoring the potential self-interference and determining the real self-interference are continued.

In some examples, due to environmental factors, fluctuations in output power of carriers, etc., the real self-interference may be generated between a plurality of carriers. The factors are uncontrollable, and the generated real self-interference may influence normal communication. Thus, in response to determining that no real self-interference is encountered by the multi-carrier combination, monitoring the potential self-interference between the plurality of carriers needs to be continued, so as to avoid the situation that the real self-interference is caused by various factors, normal communication is influenced, and loss is caused.

Through the example of the disclosure, whether the real self-interference is encountered when the terminal works under a multi-carrier condition is determined, and the instruction message is generated according to the real self-interference and transmitted to the network device, such that interference avoidance can be conducted by the network device according to the instruction message. In this way, whether the real self-interference is encountered by a plurality of carriers can be monitored, and the real self-interference can be canceled, such that influence of the real self-interference on sensitivity can be minimized.

With reference to FIG. 5, FIG. 5 is a schematic flow diagram of yet another method for canceling multi-carrier real self-interference according to an example of the disclosure. As shown in FIG. 5, the method is performed by a network device. The method may include, but is not limited to, the following steps:

S51, an instruction message transmitted by a terminal device is received. The instruction message is transmitted by the terminal device in response to determining that real self-interference is encountered by a multi-carrier combination used.

In the example of the disclosure, the instruction message includes a number of times of the real self-interference, transmission power, an interference type, etc., which may be set according to actual needs and are not limited here.

S52, interference avoidance operation is conducted on the multi-carrier combination according to the instruction message.

After the instruction message is received, the network device selects corresponding interference avoidance operation according to the real self-interference of a plurality of carriers in the instruction message.

It may be understood that different interference types correspond to different interference avoidance operation.

The instruction message includes at least one time of real self-interference. In response to determining existence of a plurality of times of real self-interference, a corresponding interference avoidance strategy needs to be selected for an interference type of each real self-interference.

In some examples, for interference avoidance operation on the multi-carrier combination, uplink and downlink work of two carriers encountering self-interference may be scheduled at different times. Working time of the two carriers is staggered, such that mutual influence between the two carriers can be avoided as much as possible, and further a possibility of the real self-interference can be reduced.

In some examples, for interference avoidance operation on the multi-carrier combination, transmission power of two carriers encountering self-interference may be adjusted. In this way, the potential self-interference between the two carriers can be reduced, and further a possibility of the real self-interference can be reduced. Optionally, transmission power of one of the two carriers encountering the self-interference is adjusted, and transmission power of the other carrier is maintained. For instance, the transmission power of one of the carriers may be decreased or increased. Optionally, the transmission power of the two carriers encountering the self-interference can be synchronously adjusted. For instance, the transmission power of one of the carriers may be decreased and the transmission power of the other carrier may be increased. For instance, the transmission power of one of the carriers may be increased and the transmission power of the other carrier may be decreased. For instance, the transmission power of one of the carriers may be decreased and the transmission power of the other carrier may be decreased. For instance, the transmission power of one of the carriers may be increased and the transmission power of the other carrier may be increased.

It is to be noted that a difference between the adjusted transmission power of the two carriers needs to be greater than the set value. Optionally, respective adjusted transmission power of the two carriers is obtained, and the difference between the adjusted transmission power is obtained. If the difference is greater than the set value, adjustment is finished. If the difference is not greater than the set value, adjustment of the transmission power of the two carriers is continued until the difference is greater than the set value, and then adjustment is finished.

Through the example of the disclosure, whether the real self-interference is encountered when the terminal works under a multi-carrier condition is determined, and the instruction message is generated according to the real self-interference and transmitted to the network device, such that interference avoidance can be conducted by the network device according to the instruction message. In this way, whether the real self-interference is encountered by a plurality of carriers can be monitored, and the real self-interference can be canceled, such that influence of the real self-interference on sensitivity can be minimized.

In the example according to the disclosure, the method according to the example of the disclosure is introduced from aspects of a terminal device and a network device separately. In order to achieve functions of the method according to the example of the disclosure, the terminal device and the network device may include hardware structures and software modules. The above functions are achieved in a form of a hardware structure, a software module, or a combination of a hardware structure and a software module. One of the above functions may be performed by a hardware structure, a software module, or a combination of a hardware structure and a software module.

FIG. 6 is a schematic structural diagram of a communication apparatus 600 according to an example of the disclosure. The communication apparatus is performed by a terminal device. The communication apparatus 600 shown in FIG. 6 may include a processing module 610 and a transceiver module 620.

The communication apparatus 600 may be a terminal device (for instance, the terminal device in the above method example), or an apparatus in a terminal device, or an apparatus used in cooperation with a terminal device.

The communication apparatus 600 is a terminal device (for instance, the terminal device in the above method example). The communication apparatus includes:
the processing module 610 configured to conduct, in response to determining that potential self-interference is encountered by a multi-carrier combination of the terminal device, real self-interference determination on the potential self-interference; and
the transceiver module 620 configured to transmit, in response to determining that real self-interference is encountered by the multi-carrier combination, an instruction message to a network device. The instruction message is configured to instruct the network device to conduct interference avoidance on the multi-carrier combination.

The processing module 610 is further configured to determine interference information of the potential self-interference; and determine whether the potential self-interference is the real self-interference according to the interference information.

The processing module 610 is further configured to determine that a plurality of potential self-interference are encountered by the multi-carrier combination; and determine, for each potential self-interference, whether the potential self-interference is the real self-interference according to the interference information of the potential self-interference.

The processing module 610 is further configured to determine current first transmission power of the terminal device and maximum second transmission power supported by the terminal device according to the interference information of the potential self-interference; obtain a difference between the first transmission power and the second transmission power; and determine, in response to determining the difference to be greater than a set value, that the potential self-interference is the real self-interference.

The processing module 610 is further configured to determine an interference type of self-interference on the basis of the interference information; determine, in response to determining that the interference type is intermodulation interference, that the plurality of carriers causing interference is encountered by the multi-carrier combination, compute the sum of the transmission power of the plurality of carriers causing interference, and obtain the first transmission power; and determine, in response to determining that the interference type is adjacent channel interference or harmonic interference, one carrier causing interference exists in the multi-carrier combination, and use the transmission power of the one carrier causing interference as the first transmission power.

The processing module 610 is further configured to determine one carrier or a plurality of carriers causing interference from the multi-carrier combination according to the interference information of the potential self-interference; compute the sum of the transmission power of the one carrier or the plurality of carriers causing interference, and determine the sum as the first transmission power; and determine maximum transmission power supported by the one carrier or the plurality of carriers causing interference as the second transmission power.

The processing module 610 is further configured to determine whether the multi-carrier combination encounters the potential self-interference according to frequency information of a carrier in the multi-carrier combination of the terminal device.

The processing module 610 is further configured to continue, in response to determining that no real self-interference is encountered by the multi-carrier combination, monitoring the potential self-interference and determining the real self-interference.

The communication apparatus 600 may also be a network device (for instance, the network device in the above method example), or an apparatus in a network device, or an apparatus used in cooperation with a network device.

The transceiver module 620 is further configured to schedule uplink and downlink work of two carriers encountering self-interference at different times.

The processing module 610 is further configured to adjust transmission power of the two carriers encountering the self-interference.

The processing module 610 is further configured to adjust transmission power of one of the two carriers encountering the self-interference, and maintain transmission power of the other carrier; and alternatively, simultaneously adjust the transmission power of the two carriers encountering the self-interference.

Through the example of the disclosure, whether the real self-interference is encountered when the terminal works under a multi-carrier condition is determined, and the instruction message is generated according to the real self-interference and transmitted to the network device, such that interference avoidance can be conducted by the network device according to the instruction message. In this way, whether the real self-interference is encountered by a plurality of carriers can be monitored, and the real self-interference can be canceled, such that influence of the real self-interference on sensitivity can be minimized.

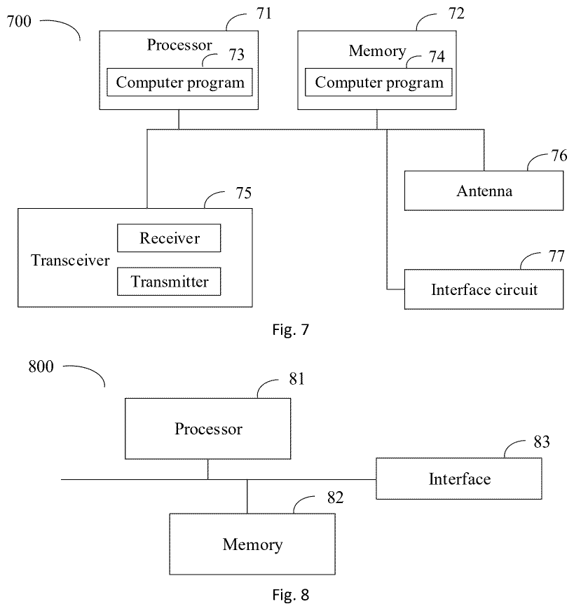

With reference to FIG. 7, FIG. 7 is a schematic structural diagram of another communication device 700 according to an example of the disclosure. The communication device 700 may be a network device, or a terminal device (for instance, the terminal device in the above method example), or a chip, a chip system or a processor that supports the network device to implement the above method, or a chip, a chip system or a processor that supports the terminal device to implement the above method. The apparatus may be configured to implement the method described in the above method example. Reference may be made to the description in the above method example for details.

The communication device 700 may include one or more processors 71. The processor 71 may be a general-purpose processor, a special-purpose processor, etc. For instance, the processor may be a baseband processor or a central processing unit. The baseband processor may be configured to process a communication protocol and communication data. The central processing unit may be configured to control the communication apparatus (for instance, a base station, a baseband chip, a terminal device, a terminal device chip, a DU, or a CU), execute a computer program, and process data of the computer program.

Optionally, the communication device 700 may further include one or more memories 72. The memory may store a computer program 74. The processor 71 executes the computer program 74, such that the communication device 700 executes the method described in the above method example. Optionally, the memory 72 may further store data. The communication device 700 and the memory 72 may be arranged separately or integrated with each other.

Optionally, the communication device 700 may further include a transceiver 77 and an antenna 76. The transceiver 77 may be referred to as a transmission-reception unit, a transmission-reception machine, a transmission-reception circuit, etc., and is configured to achieve a transceiving function. The transceiver 77 may include a receiver and a transmitter. The receiver may be referred to as a reception machine or a reception circuit, and is configured to achieve a reception function. The transmitter may be referred to as a transmission machine or a transmission circuit, and is configured to achieve a transmission function.

Optionally, the communication device 700 may further include one or more interface circuits 77. The interface circuit 77 is configured to receive a code instruction and transmit the code instruction to the processor 71. The processor 71 runs the code instruction, such that the communication device 700 executes the method described in the above method example.

The communication device 700 is a terminal device (for instance, the terminal device in the above method example). The processor 71 is configured to execute S21 in FIGS. 2, S31 and S32 in FIG. 3, and S43 in FIG. 4.

In an embodiment, the processor 71 may include the transceiver configured to achieve reception and transmission functions. For instance, the transceiver may be a transmission-reception circuit, an interface, or an interface circuit. The transmission-reception circuit, interface or interface circuit configured to achieve the reception and transmission functions may be separated or integrated. The transmission-reception circuit, interface or interface circuit may be configured to read and write codes/data. Alternatively, the transmission-reception circuit or interface or interface circuit may be configured to transmit or transfer a signal.

In an embodiment, the processor 71 may store a computer program 73. The computer program 73 runs on the processor 71, such that the communication device 700 may execute the method described in the above method example. The computer program 73 may be cured in the processor 71. In this case, the processor 71 may be implemented by hardware.

In an embodiment, the communication device 700 may include a circuit. The circuit may achieve the transmission or reception or communication function in the above method example. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured by means of various IC process technologies, such as a complementary metal oxide semiconductor (CMOS), an n-metal oxide semiconductor (NMOS), a positive channel metal oxide semiconductor (PMOS), a bipolar junction transistor (BJT), a bipolar CMOS (bicmos), silicon germanium (sige), gallium arsenide (gaas), etc.

The communication apparatus according to the above examples may be the network device or the terminal device (for instance, the terminal device in the above method example), which does not limit the scope of the communication apparatus according to the disclosure. A structure of the communication apparatus may not be limited by FIG. 7. The communication apparatus may be an independent device or may be part of a large device. For instance, the communication apparatus may be:
(1) an independent integrated circuit (IC), or a chip, or a chip system, or a subsystem;
(2) a set having one or more ICs, where the IC set may also include a storage component configured to store data and a computer program;
(3) an ASIC, for instance, a modem;
(4) a module that may be embedded in other devices;
(5) a receiver, a terminal device, an intelligent terminal device, a cellular phone, a radio device, a handset, a mobile unit, an in-vehicle device, a network device, a cloud device, an artificial intelligence device, etc.; and
(6) a different device.

In a case that the communication apparatus may be a chip or a chip system, reference may be made to a schematic structural diagram of the chip shown in FIG. 8. The chip shown in FIG. 8 includes a processor 81 and an interface 82. The number of processors 81 may be one or more. The number of interfaces 82 may be greater than one.

In the case that the chip is configured to achieve functions of the network device (for instance, the network device in the above method example) in the example of the disclosure:

The processor 81 is configured to execute S51 and S52 in FIG. 5.

In the case that the chip is configured to achieve functions of the network device in the example of the disclosure:

Alternatively, the chip further includes a memory 83. The memory 83 is configured to store a computer program and data that are necessary.

Those skilled in the art may further understand that various illustrative logical blocks and steps listed in the examples of the disclosure may be implemented by electronic hardware, computer software, or a combination of both. Whether the function is achieved by hardware or software depends on specific applications and design requirements of an entire system. Those skilled in the art may use different methods to achieve the above functions for each particular application, but such implementation is not considered to fall beyond the protection scope of the examples of the disclosure.

The disclosure further provides a readable storage medium. The readable storage medium stores an instruction. When the instruction is performed by a computer, functions of any one of the above method examples are achieved.

The disclosure further provides a computer program product. When the computer program product is performed by a computer, functions of any one of the above method examples are achieved.

The above examples may be partially or completely implemented with software, hardware, firmware or any combination of them. When implemented with software, the examples may be partially or completely implemented in the form of a computer program product. The computer program product includes one or more computer programs. When the computer program is loaded and executed on the computer, flows or functions according to the examples of the disclosure are partially or completely generated. The computer may be a general-purpose computer, a special-purpose computer, a computer network, or other programmable apparatuses. The computer program may be stored in a computer-readable storage medium or transmitted from a computer-readable storage medium to another computer-readable storage medium. For instance, the computer program may be transmitted from a website, a computer, a server or a data center to another website, another computer, another server or another data center in a wired way (for instance, a coaxial cable, an optical fiber, or a digital subscriber line (DSL)) or a wireless way (for instance, infrared waves, radio, or microwaves). The computer-readable storage medium may be any available medium that may be accessed by the computer or a data storage device such as an integration server and data center that includes one or more available media. The available medium may be a magnetic medium (for instance, a floppy disk, a hard disk, or a magnetic tape), an optical medium (for instance, a high-density digital video disc (DVD)), a semiconductor medium (for instance, a solid state disk (SSD)), etc.

Those of ordinary skill in the art may understand that numerical symbols such as “first” and “second” involved in the disclosure are only for convenience of description, instead of limiting the scope of the examples of the disclosure, and further indicate a sequence.

“At least one” in the disclosure may also be described as “one or more,” and “a plurality of” may indicate two, three, four or more, which are not limited by the disclosure. In the example of the disclosure, for a technical feature, technical features in the technical feature are distinguished by “first,” “second,” “third,” “A,” “B,” “C,” “D,” etc. The technical features described by the “first,” “second,” “third,” “A,” “B,” “C” and “D” are not in order of succession or order of size.

The corresponding relation shown in each table in the disclosure may be configured or predefined. Values of information in each table are only illustrative, and may be configured to be other values, which are not limited by the disclosure. When the correspondence between information and all parameters is configured, not all the correspondences indicated in each table have to be configured. For instance, in the table in the disclosure, the corresponding relation shown in some rows does not have to be configured. For another instance, appropriate variation and adjustment may be conducted on the basis of the above table, such as splitting and merging. Names of the parameters indicated by headings in the above tables may also be other names that may be understood by a communication apparatus, and values or representations of the parameters may also be other values or representations that may be understood by the communication apparatus. The above tables may also use other data structures during implementation, such as arrays, queues, containers, stacks, linear tables, pointers, linked lists, trees, graphs, structures, classes, heaps and hash tables.

Predefinition in the disclosure may be understood as definition, predefinition, storage, prestorage, prenegotiation, preconfiguration, curing, or prefiring.

Those of ordinary skill in the art may understand that the units and algorithm steps of the instances described in connection with the examples disclosed here may be implemented in electronic hardware, or a combination of computer software and electronic hardware. Whether the functions are executed in hardware or software depends on specific application and design constraints of the technical solution. Professionals may use different methods to implement the described functions for each specific application, but such implementation should not be considered to fall beyond the scope of the disclosure.

Those skilled in the art may clearly understand that, for the convenience and conciseness of description, reference may be made to a corresponding process in the above method example for a specific operation process of the system, apparatus and unit described above, which will not be repeated here.

What are described above are merely specific embodiments of the disclosure, and are not intended to limit the protection scope of the disclosure. Any changes or substitutions that may be easily made by those skilled in the art within the technical scope disclosed in the disclosure should fall within the protection scope of the disclosure. Thus, the protection scope of the disclosure should be subject to the protection scope of the claims.

1. A method for canceling multi-carrier real self-interference, performed by a terminal device, comprising:
conducting, in response to determining that potential self-interference is encountered by a multi-carrier combination of the terminal device, real self-interference determination on the potential self-interference; and
transmitting, in response to determining that real self-interference is encountered by in the multi-carrier combination, an instruction message to a network device, wherein the instruction message is configured to instruct the network device to conduct interference avoidance on the multi-carrier combination.

2. The method according to claim 1, wherein the conducting real self-interference determination on the potential self-interference comprises:
determining interference information of the potential self-interference; and
determining whether the potential self-interference is the real self-interference according to the interference information.

3. The method according to claim 2, wherein the determining whether the potential self-interference is the real self-interference according to the interference information comprises:
determining that a plurality of potential self-interference are encountered by the multi-carrier combination; and
determining, for potential self-interference, whether the potential self-interference is the real self-interference according to the interference information of the potential self-interference.

4. The method according to claim 2, wherein the determining whether the potential self-interference is the real self-interference comprises:
determining current first transmission power of the terminal device and maximum second transmission power supported by the terminal device according to the interference information of the potential self-interference;
obtaining a difference between the first transmission power and the second transmission power; and
determining, in response to determining the difference to be greater than a set value, that the potential self-interference is the real self-interference.

5. The method according to claim 4, wherein the determining current first transmission power of the terminal device and maximum second transmission power supported by the terminal device according to the interference information of the potential self-interference comprises:
determining one carrier or a plurality of carriers causing interference from the multi-carrier combination according to the interference information of the potential self-interference;
computing the sum of the transmission power of the one carrier or the plurality of carriers causing interference, and obtaining the first transmission power; and
determining maximum transmission power supported by the one carrier or the plurality of carriers causing interference as the second transmission power.

6. The method according to claim 5, wherein the computing the sum of the transmission power of the one carrier or the plurality of carriers causing interference, and obtaining the first transmission power comprise:
determining an interference type of self-interference on the basis of the interference information;
determining that the interference type is intermodulation interference, that the plurality of carriers causing interference exist in the multi-carrier combination, computing the sum of the transmission power of the plurality of carriers causing interference, and obtaining the first transmission power; and
determining, in response to determining that the interference type is adjacent channel interference or harmonic interference, that one carrier causing interference exists in the multi-carrier combination, and using the transmission power of the one carrier causing interference as the first transmission power.

7. The method according to claim 1, wherein the determining that potential self-interference is encountered by a multi-carrier combination of the terminal device comprises:
determining whether the potential self-interference is encountered by the multi-carrier combination according to frequency information of a carrier in the multi-carrier combination of the terminal device.

8. The method according to claim 1, further comprising:
continuing, in response to determining that no real self-interference is encountered by the multi-carrier combination, monitoring the potential self-interference and determining the real self-interference.

9. A method for canceling multi-carrier real self-interference, performed by a network device, comprising:
receiving an instruction message transmitted by a terminal device, wherein the instruction message is transmitted by the terminal device in response to determining that real self-interference is encountered by a multi-carrier combination used; and
conducting interference avoidance operation on the multi-carrier combination according to the instruction message.

10. The method according to claim 9, wherein the conducting interference avoidance operation on the multi-carrier combination comprises:
scheduling uplink and downlink work of two carriers encountering self-interference at different times.

11. The method according to claim 10, wherein the conducting interference avoidance operation on the multi-carrier combination comprises:
adjusting transmission power of the two carriers encountering the self-interference.

12. The method according to claim 11, wherein the adjusting transmission power of the two carriers encountering the self-interference comprises:
adjusting transmission power of one of the two carriers encountering the self-interference, and maintaining transmission power of the other carrier; and alternatively,
adjusting the transmission power of the two carriers encountering the self-interference simultaneously.

13.-14. (canceled)

15. A communication device, comprising a processor and a memory, wherein the memory stores a computer program, and the processor executes the computer program stored in the memory, such that the processor is configured to:
conduct, in response to determining that potential self-interference is encountered by a multi-carrier combination of the terminal device, real self-interference determination on the potential self-interference; and
transmit, in response to determining that real self-interference is encountered by in the multi-carrier combination, an instruction message to a network device, wherein the instruction message is configured to instruct the network device to conduct interference avoidance on the multi-carrier combination.

16. A communication device, comprising a processor and a memory, wherein the memory stores a computer program, and the processor executes the computer program stored in the memory, such that the communication device executes the method according to claim 9.

17. A communication device, comprising a processor and an interface circuit, wherein
the interface circuit is configured to receive a code instruction and transmit the code instruction to the processor; and
the processor is configured to run the code instruction, so as to execute the method according to claim 1.

18. A communication device, comprising a processor and an interface circuit, wherein
the interface circuit is configured to receive a code instruction and transmit the code instruction to the processor; and
the processor is configured to run the code instruction, so as to execute the method according to claim 9.

19. A computer-readable storage medium, configured to store an instruction, wherein when the instruction is executed, the method according to claim 1 is implemented.

20. A computer-readable storage medium, configured to store an instruction, wherein when the instruction is executed, the method according to claim 9 is implemented.

21. The communication device according to claim 15, wherein the processor is configured to:
determine interference information of the potential self-interference; and
determine whether the potential self-interference is the real self-interference according to the interference information.

22. The communication device according to claim 21, wherein the processor is configured to:
determine that a plurality of potential self-interference are encountered by the multi-carrier combination; and
determine, for each potential self-interference, whether the potential self-interference is the real self-interference according to the interference information of the potential self-interference.
